(19) United States
(12) Patent Application Publication
(10) Pub. No.: US 2016/0147351 A1
(43) Pub. Date: May 26, 2016

(54) ELECTRONIC DEVICE AND METHOD FOR PROTECTING DATA

(71) Applicant: Chiun Mai Communication Systems, Inc., New Taipei (TW)

(72) Inventor: CHIEN-YU LIN, New Taipei (TW)

(21) Appl. No.: 14/688,593

(22) Filed: Apr. 16, 2015

(30) Foreign Application Priority Data
Nov. 21, 2014 (CN) 201410675974.X

(51) Int. Cl. G06F 3/041; G06F 21/60; G06F 11/14

(52) U.S. Cl. CPC G06F 3/0414; G06F 11/1451; G06F 21/602

(57) ABSTRACT

A method for protecting data of an electronic device includes determining a touch region on a display panel of the electronic device and acquiring touch points on the touch region using a pressure sensor of the electronic device, in response to detecting that the display panel has been pressed using the pressure sensor. A pressure value of each of the touch points is acquired using the pressure sensor. According to the pressure value of each of the touch points, an average pressure value on the touch region is computed. A preset pressure value is acquired. When the average pressure value is more than the preset pressure value, it is determined that whether the display panel is functioning. When the display panel is not functioning, data in the storage device is protected by encrypting the data.

### CROSS-REFERENCE TO RELATED APPLICATIONS

This application claims priority to Chinese Patent Application No. 201410675974.X filed on Nov. 21, 2014, the contents of which are incorporated by reference herein.

### FIELD

The subject matter herein generally relates to data security technology, and particularly to an electronic device and a method for protecting data using the electronic device.

### BACKGROUND

When a display panel of an electronic device is broken, a user of the electronic device cannot view data stored in a storage device of the electronic device through the display panel. When the display panel is repaired by other people, the data can be leaked out.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including a protection system.

FIG. 2 is a block diagram of one embodiment of function modules of the protection system in the electronic device of FIG. 1.

FIG. 3 illustrates a flowchart of one embodiment of a method for protecting data using the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation.

Several definitions that apply throughout this disclosure will now be presented. It should be noted that references to “an” or “one” embodiment in this disclosure are not necessarily to the same embodiment, and such references mean “at least one.” Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

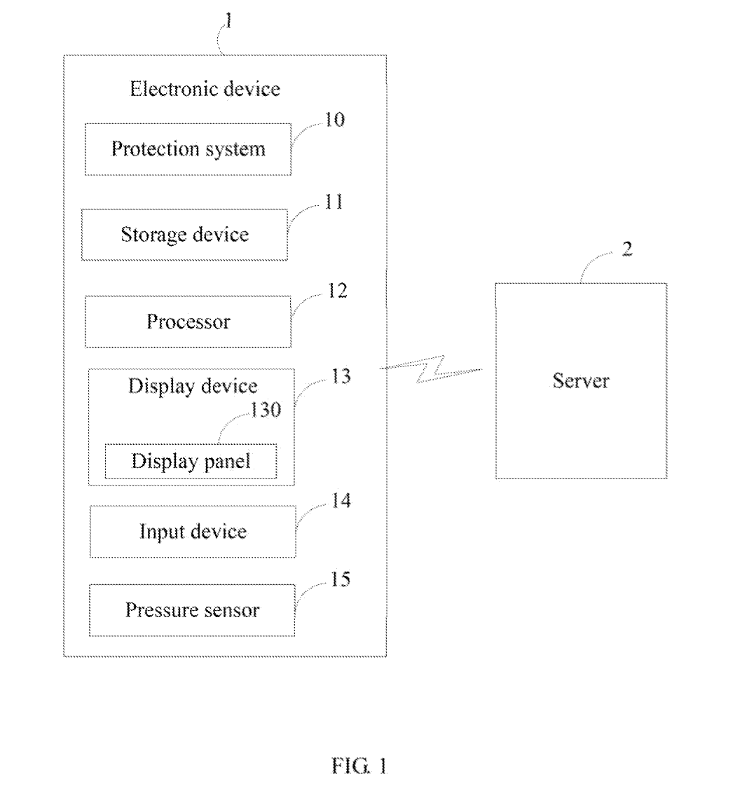

FIG. 1 illustrates a block diagram of one embodiment of an electronic device. In at least one embodiment as shown in FIG. 1, an electronic device 1 includes, but is not limited to, a protection system 10, a storage device 11, at least one processor 12, a display device 13, an input device 14 and at least one pressure sensor 15. The display device 13 includes a display panel 130. The electronic device 1 can be a tablet computer, a notebook computer, a smart phone, a personal digital assistant (PDA), or another suitable electronic device. FIG. 1 illustrates only one example of the electronic device that can include more or fewer components than illustrated, or have a different configuration of the various components in other embodiments.

In at least one embodiment, the pressure sensor 15 can detect whether the display panel 130 has been pressed by a finger of a user, a stylus or any other tool. When the display panel 130 has been pressed, the pressure sensor 130 can detect a touch region and a plurality of touch points on the touch region. The pressure sensor 130 can detect each pressure value of each of the touch points. In at least one embodiment, the electronic device 1 can be connected to a server 2. When the display panel 130 is not functioning (e.g., a circuit break) is occurred on the display panel 130, the protection system 10 can generate backup data of the storage device 11 and upload the backup data to the server 2. Therefore, a user of the electronic device can download the backup data from the server 2.

In at least one embodiment, when the display panel 130 has been pressed, the protection system 10 can detect whether the circuit break is occurred on the display panel 130. When the circuit break is occurred, the protection system 10 can protect data in the storage device 11 by encrypting the data.

In at least one embodiment, the storage device 11 can include various types of non-transitory computer-readable storage mediums. For example, the storage device 11 can be an internal storage system, such as a flash memory, a random access memory (RAM) for temporary storage of information, and/or a read-only memory (ROM) for permanent storage of information. The storage device 11 can also be an external storage system, such as a hard disk, a storage card, or a data storage medium. The at least one processor 12 can be a central processing unit (CPU), a microprocessor, or other data processor chip that performs functions of the protection system 10 in the electronic device 1. The display device 13 can display images and videos, and the input device 14 can be a mouse, a keyboard, or a touch panel.

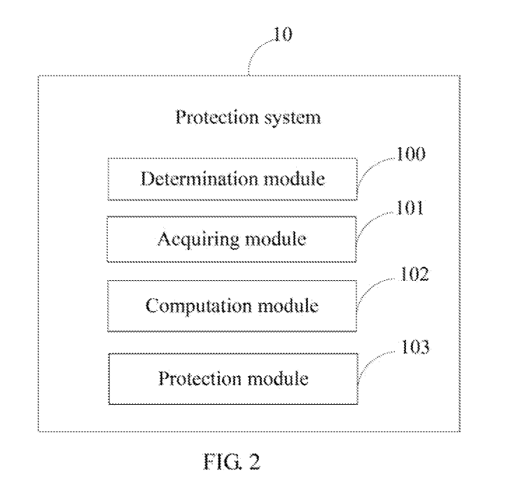

FIG. 2 is a block diagram of one embodiment of function modules of the protection system. In at least one embodiment, the protection system 10 can include a determination module 100, an acquiring module 101, a computation module 102, and a protection module 103. The function modules 100, 101, 102, and 103 can include computerized codes in the form of one or more programs, which are stored in the storage device 11. The at least one processor 12 executes the computerized codes to provide functions of the function modules 100-103.

The determination module 100 determines whether the display panel 130 has been pressed using the pressure sensor 15. When the pressure sensor 15 receives one or more pressed signals from the display panel 130, the determination module 100 determines that the display panel 130 has been pressed. When no pressed signals is received from the display panel 130 by the pressure sensor 15, the determination module 100 determines that the display panel 130 has not been pressed.

When the determination module 100 determines that the display panel 130 has been pressed using the pressure sensor 15, the determination module 100 determines a touch region on the display panel 130. The touch region includes a plurality of touch points. The determination module 100 acquires the touch points using the pressure sensor 15.

The pressure sensor 15 detects a pressure value of each of the touch points. The acquiring module 101 acquires the pressure value of each of the touch points from the pressure sensor 15.

According to the pressure value of each of the touch points, the computation module 102 computes an average pressure value on the touch region. In at least one embodiment, the computation module 102 computes the average pressure value by dividing a sum of the pressure value of each of the touch points by a number of the touch points. In other embodiments, the computation module 102 computes the average pressure value by dividing the sum of the pressure value of each of the touch points by an area of the touch region.

The acquiring module 101 acquires a preset pressure value presorted in the storage device 11 based on a model of the electronic device. In at least one embodiment, the preset pressure value is related to a model of the electronic device 1. Different models can be built according to different material of display panels of different electronic devices. Different materials of display panels correspond to different maximum pressure values.

The determination module 100 determines whether the average pressure value is more than the preset pressure value. When the average pressure value is more than the preset pressure value, the determination module 100 determines whether a circuit break is occurred. When the average pressure value is not more than the preset pressure value, the determination module 100 re-determines whether the display panel 130 has been pressed.

In at least one embodiment, when the circuit break is occurred on the display panel 130, a feedback signal is sent by the processor 12. When the determination module 100 receives the feedback signal corresponding to the circuit break of the display panel 130, the determination module 100 determines that the circuit break is occurred. When the determination module 100 does not receive any feedback signal corresponding to the circuit break of the display panel 130, the determination module 100 determines that no circuit break is occurred on the display panel 130, the determination module 100 re-determines whether the display panel 130 has been pressed.

In at least one embodiment, when the circuit break is occurred, the protection module 103 protects data in the storage device 11 by encrypting the data. In other embodiments, when the circuit break is occurred, the protection module 103 generates backup data of the storage device 11 and uploads the backup data to the server 2.

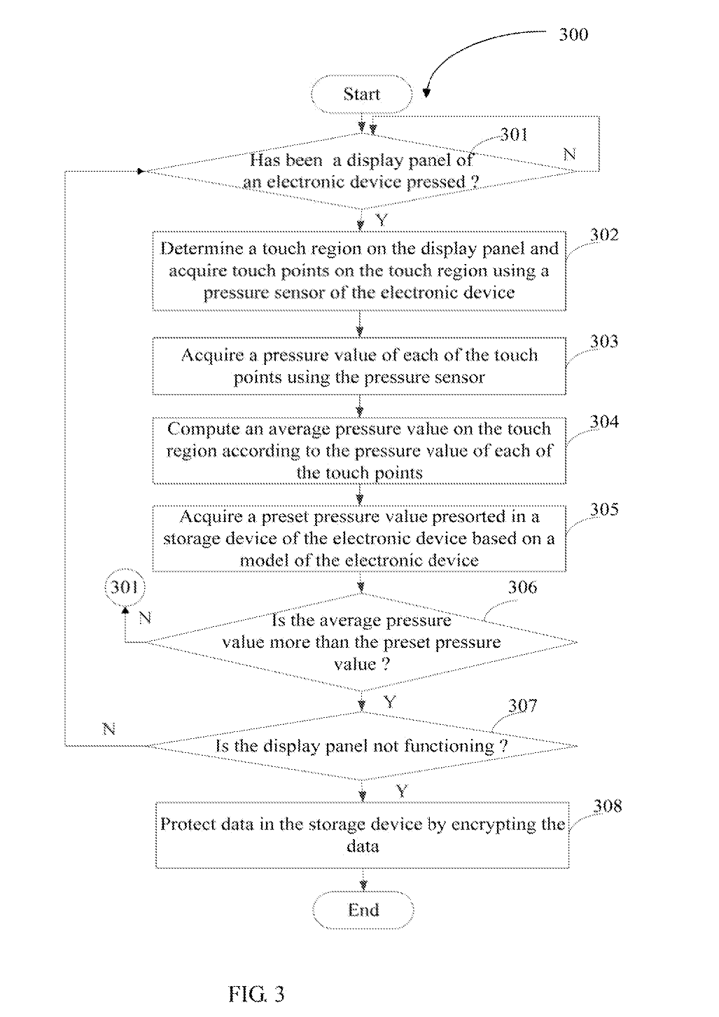

FIG. 3 illustrates a flowchart is presented in accordance with an example embodiment. An example method 300 is provided by way of example, as there are a variety of ways to carry out the method. The example method 300 described below can be carried out using the configurations illustrated in FIGS. 1 and 2 for example, and various elements of these figures are referenced in explaining example method 300. Each block shown in FIG. 3 represents one or more processes, methods, or subroutines carried out in the example method 300. Furthermore, the illustrated order of blocks is illustrative only and the order of the blocks can be changed according to the present disclosure. The example method 300 can begin at block 301. Depending on the embodiment, additional blocks may be utilized and the ordering of the blocks can be changed.

At block 301, a determination module determines whether a display panel of an electronic device has been pressed using a pressure sensor of the electronic device. When the pressure sensor receives one or more pressed signals from the display panel, the determination module determines that the display panel has been pressed. When no pressed signals is received from the display panel by the pressure sensor, the determination module determines that the display panel has not been pressed.

At block 302, when the determination module determines that the display panel has been pressed using the pressure sensor, the determination module determines a touch region on the display panel. The touch region includes a plurality of touch points. The determination module acquires the touch points using the pressure sensor. When the determination module determines that the display panel has not been pressed using the pressure sensor, the procedure returns to the block 301.

At block 303, the pressure sensor detects a pressure value of each of the touch points. An acquiring module acquires the pressure value of each of the touch points from the pressure sensor.

At block 304, according to the pressure value of each of the touch points, a computation module computes an average pressure value on the touch region. In at least one embodiment, the computation module computes the average pressure value by dividing a sum of the pressure value of each of the touch points by a number of the touch points. In other embodiments, the computation module computes the average pressure value by dividing the sum of the pressure value of each of the touch points by an area of the touch region.

At block 305, the acquiring module acquires a preset pressure value presorted in a storage device of the electronic device based on a model of the electronic device. In at least one embodiment, the preset pressure value is related to a model of the electronic device. Different models can be built according to different material of display panels of different electronic devices. Different materials of display panels correspond to different maximum pressure values.

At block 306, the determination module determines whether the average pressure value is more than the preset pressure value. When the average pressure value is more than the preset pressure value, the procedure goes to a block 307, the determination module determines whether a circuit break is occurred. When the average pressure value is not more than the preset pressure value, the procedure returns to the block 301, the determination module re-determines whether the display panel has been pressed.

At block 307, In at least one embodiment, when the circuit break is occurred on the display panel, a feedback signal is sent by a processor of the electronic device. When the determination module receives the feedback signal corresponding to the circuit break of the display panel, the determination module determines that the circuit break is occurred, the procedure goes to a block 308. When the determination module does not receive any feedback signal corresponding to the circuit break of the display panel, the determination module determines that no circuit break is occurred on the display panel, the procedure returns to the block 301, the determination module re-determines whether the display panel has been pressed.

At block 308, In at least one embodiment, when the circuit break is occurred, the protection module protects data in the storage device by encrypting the data. In other embodiments, when the circuit break is occurred, the protection module generates backup data of the storage device and uploads the backup data to a server that is connected to the electronic device.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for protecting data of an electronic device being executed by a processor of the electronic device, the method comprising:
determining a touch region on a display panel of the electronic device and acquiring touch points on the touch region using a pressure sensor of the electronic device, in response to detecting that the display panel has been pressed using the pressure sensor;
acquiring a pressure value of each of the touch points using the pressure sensor;
computing an average pressure value on the touch region according to the pressure value of each of the touch points;
acquiring a preset pressure value presorted in a storage device of the electronic device based on a model of the electronic device;
determining whether the display panel is not functioning when the average pressure value is more than the preset pressure value; and
protecting data in the storage device by encrypting the data when the display panel is not functioning.

2. The method according to claim 1, wherein the average pressure value is computed by dividing a sum of the pressure value of each of the touch points by a number of the touch points.

3. The method according to claim 1, wherein the average pressure value is computed by dividing the sum of the pressure value of each of the touch points by an area of the touch region.

4. The method according to claim 1, further comprising:
generating backup data of the storage device and uploading the backup data to a server which is connected to the electronic device when the display panel is not functioning.

5. An electronic device, comprising:
at least one processor; and
a storage device that stores one or more programs, when executed by the at least one processor, cause the at least one processor to:
determine a touch region on a display panel of the electronic device and acquire touch points on the touch region using a pressure sensor of the electronic device, in response to detecting that the display panel has been pressed using the pressure sensor;
acquire a pressure value of each of the touch points using the pressure sensor;
compute an average pressure value on the touch region according to the pressure value of each of the touch points;
acquire a preset pressure value presorted in a storage device of the electronic device based on a model of the electronic device;
determine whether the display panel is not functioning when the average pressure value is more than the preset pressure value; and
protect data in the storage device by encrypting the data when the display panel is not functioning.

6. The electronic device according to claim 5, wherein the average pressure value is computed by dividing a sum of the pressure value of each of the touch points by a number of the touch points.

7. The electronic device according to claim 5, wherein the average pressure value is computed by dividing the sum of the pressure value of each of the touch points by an area of the touch region.

8. The electronic device according to claim 5, wherein the at least one processor further generates backup data of the storage device and uploads the backup data to a server which is connected to the electronic device when the display panel is not functioning.

9. A non-transitory storage medium having stored thereon instructions that, when executed by a processor of an electronic device, causes the processor to perform a protection method, wherein the method comprises:
determining a touch region on a display panel of the electronic device and acquiring touch points on the touch region using a pressure sensor of the electronic device, in response to detecting that the display panel has been pressed using the pressure sensor;
acquiring a pressure value of each of the touch points using the pressure sensor;
computing an average pressure value on the touch region according to the pressure value of each of the touch points;
acquiring a preset pressure value presorted in a storage device of the electronic device based on a model of the electronic device;
determining whether the display panel is not functioning when the average pressure value is more than the preset pressure value; and
protecting data in the storage device by encrypting the data when the display panel is not functioning.

10. The non-transitory storage medium according to claim 9, wherein the average pressure value is computed by dividing a sum of the pressure value of each of the touch points by a number of the touch points.

11. The non-transitory storage medium according to claim 9, wherein the average pressure value is computed by dividing the sum of the pressure value of each of the touch points by an area of the touch region.

12. The non-transitory storage medium according to claim 9, wherein the method further comprises generating backup data of the storage device and uploading the backup data to a server which is connected to the electronic device when the display panel is not functioning.
